(19) United States
(12) Patent Application Publication
(10) Pub. No.: US 2019/0104422 A1
(43) Pub. Date: Apr. 4, 2019

(54) System and Method for Easy Configuration and Authentication of Network Devices

(71) Applicant: Senao Networks, Inc., Taoyuan City (TW)

(72) Inventors: Chung-Yen Chiang, Taoyuan (TW); Cheng-Ta Lee, Taipei (TW); Shang-I Huang, Taoyuan (TW)

(73) Assignee: Senao Networks, Inc., Taoyuan City (TW)

(21) Appl. No.: 15/858,313

(22) Filed: Dec. 29, 2017

(30) Foreign Application Priority Data
Sep. 29, 2017 (TW) 106133205

(51) Int. Cl. H04W 24/02; H04W 48/08; H04W 8/00; H04W 12/06

(52) U.S. Cl. CPC H04W 24/02; H04W 48/08; H04W 84/18; H04W 12/06; H04W 8/005

(57) ABSTRACT

Systems and methods for managing a wireless mesh network, in particular to provide for the simple configuration of a plurality of unconfigured devices to be added to the wireless mesh network are disclosed. New devices in the vicinity of a wireless mesh network broadcast signals, such as beacons, advertising their ability to join the wireless mesh network. These beacons may be detected by a primary device, such as a primary router, that is part of and can manage the wireless mesh network. The primary device is then able to establish temporary connections with the new devices that are eligible to join the wireless mesh network. The primary device may generate a list of potential new nodes for presentation to an electronic device, such as a smartphone, from which a user can select a plurality of new devices to add as new nodes. Alternatively, the primary device automatically adds devices as nodes to the wireless mesh network based on various criteria.

### RELATED APPLICATIONS

The present application claims the priority of Taiwan Patent Application No. 106133205, filed on Sep. 29, 2017, the disclosure of which is hereby incorporated by reference herein.

### FIELD OF THE INVENTION

The present invention relates to wireless mesh networks, and more particularly to the streamlined configuration of new nodes for wireless mesh networks.

### BACKGROUND OF THE INVENTION

In the last several years, wireless local area networking (wireless LAN or WLAN), has seen great adoption by both the enterprise and consumer markets. Particularly with the advent of revisions of the IEEE 802.11 standard that promise ever greater performance, wireless LAN technology has truly become ubiquitous, and for many companies and homes, it is a perfectly adequate, or even superior, alternative to Ethernet and other kinds of traditional wired networking.

WLAN technology is by no means perfect, and has a number of disadvantages compared to wired networking approaches. That WLAN relies on the transmission and reception of wireless signals means that it is fundamentally more susceptible to issues such as noise and propagation loss. Wireless signals can also lose strength as they pass through walls and other obstructions. The degradation in signal quality due to an obstruction can differ based on such factors such as the material of the obstruction (e.g., wood, glass, metal) or the thickness of the obstruction. Also, the ever increasing prevalence of wireless and RF equipment has resulted in noisier environments with greater potential to interfere with WLAN signals, particularly those in the 2.4 GHz band. More current WLAN devices are also able to transmit at good speeds on other frequency bands, such as the 5 GHz band, which is less susceptible to interference. However, other bands are subject to their own tradeoffs as well. For instance, signals on the 5 GHz band generally cannot travel as far as signals on the 2.4 GHz band.

The presence of issues such as the ones described above have made WLAN an imperfect solution for many businesses and homes. In many business and homes, it has been customary to set up networks with a only single wireless router to service all of the wireless devices. However, a single router may not be adequate for many businesses or homes, depending on their size and configuration.

Wireless mesh networks for local area networking have become popular in recent years in part because they overcome some of the shortcomings of single router WLAN networks. Wireless mesh networks contain multiple nodes—routers and/or access points—working in concert to deliver data within a network. The multiple nodes can be strategically placed within an office or home to eliminate dead spots and to ensure that the signal strength is adequate wherever the LAN is needed. That is, a mesh network can extend the range and coverage area otherwise achievable by a single wireless node. A mesh network can also be more reliable than a conventional network configuration by providing redundant paths for data traffic, which can allow for uninterrupted communications even if a node fails.

However, existing wireless mesh networks have not been easy for most consumers to set up. Traditionally, setting up a wireless mesh network or to add nodes to an existing wireless mesh network have required complicated the configuration of numerous parameters.

One of the most challenging aspects of the setup of wireless mesh networks each node needed to be configured individually. This meant that the more nodes that one wished to add to a wireless mesh network, the more laborious configuration work one had to undertake.

A need therefore exists for a simple way to configure a wireless mesh network, particularly to simultaneously add multiple nodes to a wireless mesh network.

### SUMMARY OF THE INVENTION

In order to solve the above-mentioned problems, the present invention provides systems and methods for the simple configuration of wireless mesh networks, in particular to add nodes to such networks.

In the present invention, new devices in the vicinity of a wireless mesh network broadcast signals, such as beacons, advertising their ability to join the wireless mesh network. These beacons may be detected by a primary device, such as a primary router, that is part of and can manage the wireless mesh network. The primary device is then able to establish temporary connections with the new devices that are eligible to join the wireless mesh network.

In some embodiments, the primary device generates a list of potential new nodes for presentation to an electronic device, such as a smartphone, from which a user can select a plurality of new devices to add as new nodes. In other embodiments, the primary device automatically adds devices as nodes to the wireless mesh network based on various criteria.

### BRIEF DESCRIPTION OF THE DRAWINGS

Other objects and advantages of the present invention will become apparent to those skilled in the art upon reading the following detailed description and upon reference to the drawings in which:

FIG. 1 shows an exemplary communication system according to an embodiment of the present invention.

FIG. 2 is a flowchart of the operation of a communication system according to an embodiment of the present invention.

FIG. 3 is a detailed flowchart of a communication system according to an embodiment of the present invention.

FIGS. 4A-4C show exemplary user interface screens by which a user can add new nodes to a wireless mesh network.

FIG. 5 is a block diagram illustrating the structure of a learning data unit according to an embodiment of the present invention.

FIG. 6 is a block diagram illustrating the structure of a mesh simple configuration and authentication (MSCA) data unit according to an embodiment of the present invention.

### DETAILED DESCRIPTION OF THE INVENTION

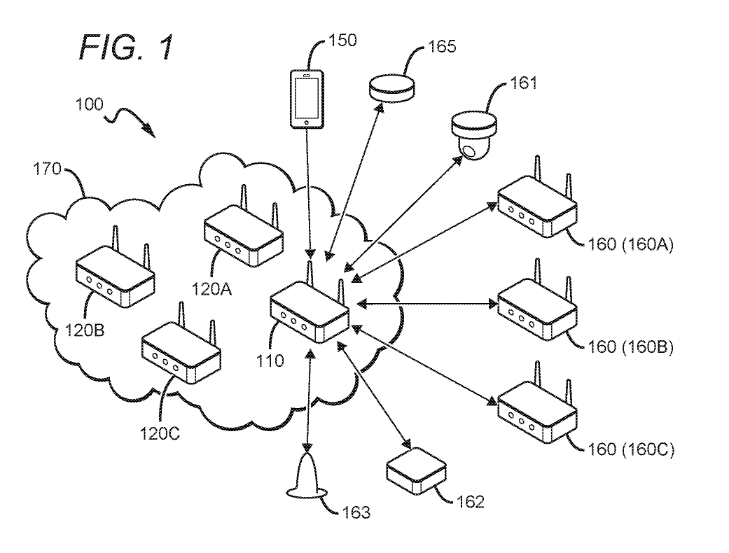

FIG. 1 shows an exemplary communication system 100 according to an embodiment of the present invention. The communication system 100 includes a primary router 110 and a number of secondary routers 120A, 120B, and 120C, each of which is communicatively coupled to one or more of the others to form a wireless mesh network 170. In operation, any of the routers of the mesh network may possibly serve as the primary router, and the routers in a mesh network may dynamically change roles as a primary or secondary router. Each of the routers within the wireless mesh network 170 may also be referred to as a node of the network. It should be noted that while the present description refers primarily to routers, a person of ordinary skill would appreciate that the teachings herein are equally applicable to wireless access points and other types of wireless base stations and devices.

An electronic device 150 is communicatively coupled to the wireless mesh network 170 and to the primary router 110 in particular. The electronic device 150 may be a smartphone, tablet, personal computer, or any other device that may be communicatively coupled to the wireless mesh network 170. In some embodiments, the electronic device 150 is capable of setting a plurality of parameters of the wireless mesh network 170, and may provide a user with the ability to set such parameters using an browser-based or native app interface.

The communication system 100 also includes a plurality of devices that are initially not part of the wireless mesh network 170 but may be configured to join the wireless mesh network in accordance with embodiments of the present invention. As illustrated in FIG. 1, examples of such devices may include additional routers 160A, 160B, and 160C, a camera 161, a media player 162, an alarm system 163, ora smart home hub 164. Devices that are capable of joining a wireless mesh network but have not yet been configured to do so may be referred to as unconfigured devices.

In some embodiments, each network node in the wireless mesh network 170 stores information regarding other network nodes within the wireless mesh network 170 and to form the routing required for data delivery.

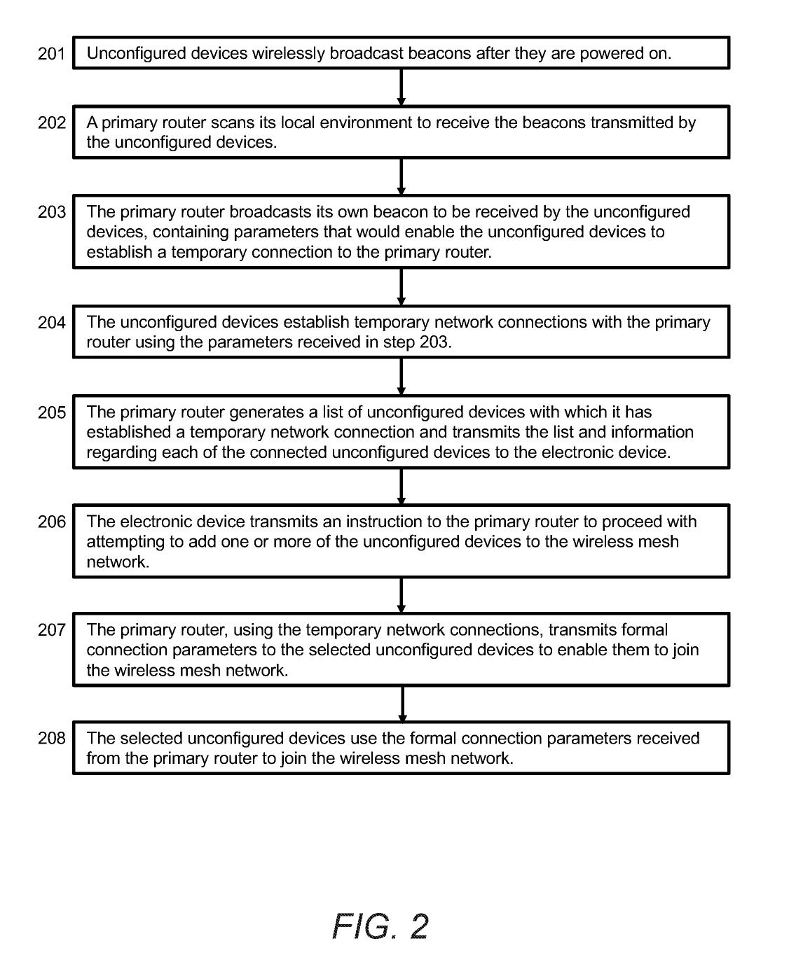

FIG. 2 is a flowchart of the operation of a communication system according to some embodiments of the present invention.

In step 201, unconfigured devices, such as devices 160-165 illustrated in FIG. 1, wirelessly broadcast beacons after they are powered on. Each beacon may include information indicating whether the device is capable of joining a wireless mesh network, and may include additional information specific to the device, such as its manufacturer serial number, regulatory domain, device type, and MAC address. In some embodiments, such information may be included in a beacon frame formatted in accordance with the IEEE 802.11 standard. The unconfigured devices may continually broadcast the beacon.

In step 202, the primary router 110 scans its local environment to receive the beacons transmitted by the unconfigured devices. In some embodiments, this operation is triggered by a user of electronic device 150. In other embodiments, this operation is automatically performed by the primary router 110 without user intervention. Using information contained in the beacons, the primary router 110 identifies the unconfigured devices in its vicinity and determines that they are capable of joining the wireless mesh network 170. In some cases, certain devices that are not capable of joining a wireless mesh network may nevertheless broadcast beacons. The primary router 110 would not attempt to add these devices to the wireless mesh network 170.

In step 203, the primary router 110 broadcasts its own beacon to be received by the unconfigured devices, containing parameters that would enable the unconfigured devices to establish a temporary connection to the primary router 110. In some embodiments, the temporary connection parameters include a temporary network identification code (e.g., a temporary mesh network identification code), one or more encrypted passwords and/or security keys, and/or any other parameter that may be used to establish a temporary connection between two wireless devices.

In step 204, the unconfigured devices establish temporary network connections with the primary router 110 using the parameters received in step 203. In some embodiments, the temporary network connection may be a temporary WDS (wireless distribution system) link. The temporary network connection may be restricted. For example, the temporary network connection may be configured to allow each unconfigured device to communicate with primary router 110, and disallow unconfigured devices from communicating with any of the secondary routers 120A, 120B, and 120C, any client devices that may be connected to the wireless mesh network 170, or the internet.

In step 205, the primary router 110 generates a list of unconfigured devices with which it has established a temporary network connection and transmits the list and information regarding each of the connected unconfigured devices to the electronic device 150.

In step 206, the electronic device 150 transmits an instruction to the primary router 110 to proceed with attempting to add one or more of the unconfigured devices to the wireless mesh network 170. For instance, in the communication system depicted in FIG. 1, the instruction may be to add each of devices 160-165 to the wireless mesh network 170, or it may be to add only certain devices to the wireless mesh network. In some embodiments, the selection of devices to add to the wireless mesh network is done by a user through a user interface on the electronic device. In other embodiments, the selection of devices to add to the wireless mesh network is done automatically by the primary router 110. For instance, the primary router 110 may simply add all eligible unconfigured devices to the mesh wireless network 170. Alternatively, the primary router 110 may automatically determine a subset of eligible unconfigured devices to be added based on various factors, such as the types of the devices, a maximum number of nodes desired for the wireless mesh network, signal strength, and device capabilities such as transmission and reception speed.

In step 207, the primary router 110, using the temporary network connections, transmits formal connection parameters to the selected unconfigured devices to enable them to join the wireless mesh network 170. In some embodiments, the formal connection parameters may include an identification code for the wireless mesh network as well as one or more passwords and security keys.

In step 208, the selected unconfigured devices use the formal connection parameters received from the primary router 110 to join the wireless mesh network 170.

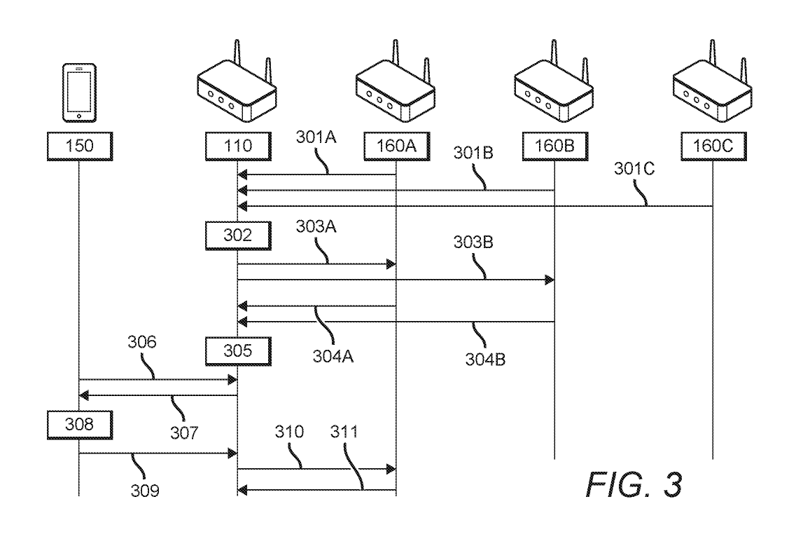

FIG. 3 illustrates exemplary devices involved in the process in accordance with some embodiments of the invention, exemplary steps performed by the devices, and exemplary time-ordered communication sequences between the device.

Unconfigured routers 160A, 160B, and 160C each communicates a beacon to the primary router 110 through transmissions 301A, 301B, and 301C, respectively.

After receiving the beacons from unconfigured routers 160A, 160B, and 160C, the primary router 110 in step 302 determines from the information contained in the beacons that unconfigured routers 160A and 160B are capable of joining the wireless mesh network of which the primary router 110 is a part. In the example of FIG. 3, primary router 110 determines in step 302 that unconfigured router 160C is incapable of joining the wireless mesh network, which can occur for various reasons, including that the beacon from unconfigured router 160C expressly indicates that it is not compatible or is missing information that the primary router 110 expects to receive from compatible devices. Of course, if the primary router 110 never receives a beacon from unconfigured router 160C at all, perhaps because it is too distant, that would be another reason it cannot be added to the wireless mesh network.

The primary router 101 then transmits, to each of unconfigured routers 160A and 160B a beacon containing temporary connection parameters in transmissions 303A and 303B, respectively. In some embodiments, the primary router 101 may direct separate transmissions to each of the unconfigured routers. In other embodiments, the primary router broadcasts a single beacon that is received by all unconfigured routers in its vicinity.

Unconfigured routers 160A and 160B then transmit signals 304A and 304B, respectively, to establish temporary connections to the primary router 110.

In step 305, the primary router 110 generates a list of new nodes that includes unconfigured routers 160A and 160B. Unconfigured router 160C is not included in the list of new nodes because it has not established a temporary network connection with the primary router 110. In some embodiments, the primary router 110 can generate the list of new nodes after receiving the initial beacons from unconfigured routers 301A, 301B, and 301C.

In some embodiments, the above described operations may be performed repeatedly by a primary router and unconfigured devices in its vicinity in order to provide constantly refreshed views as to the presence of devices that may be eligible for joining a wireless mesh network. In some embodiments, the above described operations may be performed by the primary router and unconfigured devices automatically upon power on. In other embodiments, the above described operations are triggered by a user, such as by transmitting a command using electronic device 150 or pushing setup buttons on the various devices.

The electronic device sends a request 306 to the primary router 110 to obtain the list of new nodes. In response, the primary router 110 sends response 307 containing the list of new nodes to the electronic device 150.

In step 308, the electronic device 150 presents the list of new nodes to a user, for instance, in a graphical user interface, to allow the user to select devices to add to the wireless mesh network 170. The electronic device 150 transmits signal 309 to the primary router 110 with a selection of devices. Suppose that in this example, the user elects to add unconfigured router 160A, but not unconfigured router 160B, to the wireless mesh network 170. This election would be reflected in signal 309.

The primary router 110 then sends signal 310 to unconfigured router 160A with information to allow it to join the wireless mesh network 170, such as encrypted security credentials. This information is not directed to unconfigured router 160B because the user did not elect to add it to the wireless mesh network and is not directed to unconfigured router 160C because its beacon in signal 302C indicated that it was not capable of joining the wireless mesh network. In some embodiments, the primary router sends a single signal that may be deciphered and used by a plurality unconfigured devices selected to join a wireless mesh networks. In other embodiments, the primary router sends a separate signal to each of a plurality of unconfigured devices selected to join a wireless mesh networks.

In step 311, the unconfigured router 160A uses the received credentials to configures itself to join the wireless mesh network. In some embodiments, it may at this time disconnect from its temporary network connection with the primary router 110. The now configured router 160A sends signal 311 to the primary router 110 to authenticate itself as a node of wireless mesh network 170.

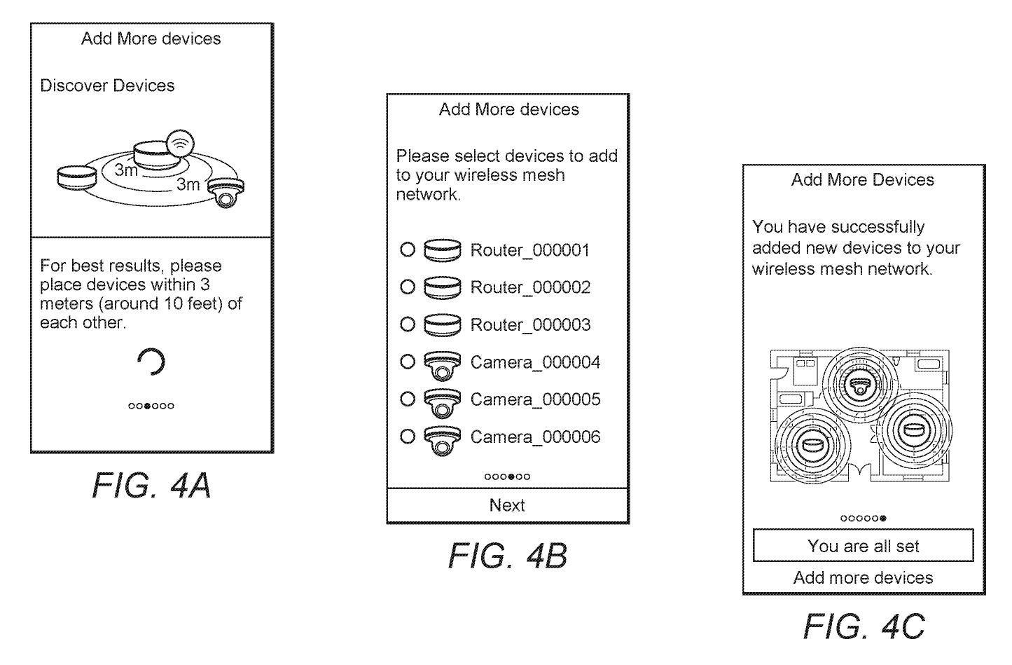

FIGS. 4A-4C show exemplary user interface screens running on electronic device 150 by which a user can add new nodes to a wireless mesh network.

FIG. 4A shows a screen that informs the user that the wireless mesh network is scanning the environment to detect and identify unconfigured devices that may be capable of joining the wireless mesh network. In some embodiments, the scanning may be continually done. In other embodiments, the scanning is triggered by the user. The screen may provide information to the user to help improve the effectiveness of the scanning operation, such as advice regarding the optimum placemen of the devices.

FIG. 4B shows a screen that provides a list of unconfigured devices in the vicinity that may be added to the wireless mesh network. The screen shows the type of the device as a well as a unique identifier for each device. Additionally, the screen provides controls to allow the user to select devices to add to the wireless mesh network.

FIG. 4C shows a screen that provides an overview of devices forming the wireless mesh network. A variety of information can be provided regarding the wireless mesh network and the devices comprising the network in order to assist the user in improving the performance of the network. For instance, information regarding the locations of each device may be provided, and icons representing each device may be overlaid on a floorplan of the physical environment, such as an office or home. The screen may also provide, via textual or graphical indications, information such as the signal strength and data throughput of each node, or the data volume handled by each node. A user can use such information to experiment with different placements of the devices in order to improve overall performance of the wireless mesh network. Such information can also be useful to inform the user of locations where it may be desirable to add one or more nodes to the wireless mesh network. In some embodiments, the electronic device 150 can use the gathered information to automatically determine an optimum number of devices and their placement for the user.

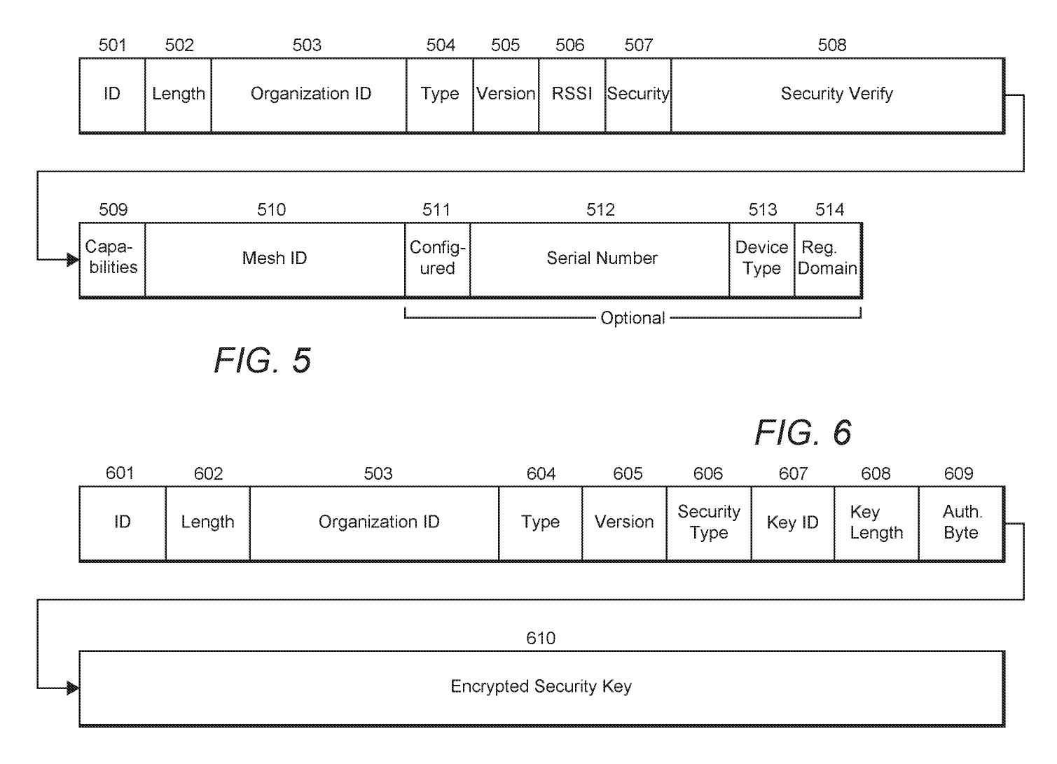

FIG. 5 is a block diagram illustrating the structure of a learning data unit according to an embodiment of the present invention. In some embodiments, the learning data unit may be implemented as a WDS (wireless distribution system) Learning IE (information element) included in a beacon frame or probe response frame formatted in accordance with the IEEE 802.11 standard.

The fields of the learning data unit are as follows:
ID field 501 provides an identifier for the data unit. This may also be referred to as an information element identifier (1E1). The ID field may indicate a vendor-specific data unit.
Length field 502 indicates the length of the learning data unit in order to assist a receiver in deciphering the data unit without error.
Organization ID field 503 identifies an organization associated with the device, such as the original equipment manufacturer of the device or a company that markets the device under its own brand name.
Type field 504 indicate the type of the data unit, in particular a learning data unit.
Version field 505 represents the version of the mesh network implementation. This field can be used to verify compatibility between devices.
RSSI (relative received signal strength indicator) field 506 indicates the strength of the signal received by the sender. For instance, if sent by an unconfigured device, this field may represent the strength of the signal that it receives from the primary router of a wireless mesh network in its vicinity.
Security field 507 indicates the type of encryption used by the device.
Security Verify field 508 provides a security number for use in cryptographic operations.
Capabilities field 509 provides information regarding the technical capability of the device, such as whether it has a 2×2 or 3×3 antenna configuration.
Mesh ID field 510 identifies a wireless mesh network to which the sending device belongs. If sent by an unconfigured device that has not joined a wireless mesh network, this field may be set to a default value.
Configured field 511 is an optional field that indicates that this node is configured or unconfigured
Serial Number field 512 is an optional field that indicates the serial number of the device.
Device Type field 513 is an optional field that indicates the type of the sending device, which may be a router, access point, or another type of device that can join a wireless mesh network.
Regulatory Domain field 514 represents the applicable regulatory domain, such as the FCC in the U.S. or ETSI in Europe.

FIG. 6 is a block diagram illustrating the structure of a mesh simple configuration and authentication (MSCA) data unit according to an embodiment of the present invention. In some embodiments, the MSCA data unit may be implemented as an information element included in a beacon frame or probe response frame formatted in accordance with the IEEE 802.11 standard.

The fields of the MSCA data unit are as follows:
ID field 601 provides an identifier for the data unit. This may also be referred to as an information element identifier (IEI). The ID field may indicate a vendor-specific data unit.
Length field 602 indicates the length of the MSCA data unit in order to assist a receiver in deciphering the data unit without error.
Organization ID field 603 identifies an organization associated with the device, such as the original equipment manufacturer of the device or a company that markets the device under its own brand name.
Type field 604 indicate the type of the data unit, in particular an MSCA data unit.
Version field 605 represents the version of the mesh network implementation. This field can be used to verify compatibility between devices.
Security Type field 606 represents indicates the type of encryption used by the device.
Key ID field 607 identifies an encryption key, if one is needed by the type of encryption used by the device. For instance, the field may be populated for WEP but not for WPA/WPA2 security.
Key Length field 608 represents the length of the encryption key, if needed by the type of encryption used by the device, such as WEP security.
Authorization Byte field 609 indicates whether the data unit contains credentials for establishing a temporary connection.
Encrypted Security Key field 610 provides the encrypted security key for joining the wireless mesh network.

It should be understood that while this invention has been described in connection with particular examples thereof, no limitation is intended thereby since obvious modifications will become apparent to those skilled in the art after having the benefit of studying the foregoing specification, drawings and following claims.

We claim:

1. A method for joining a plurality of unconfigured network devices to a wireless mesh network managed by a primary device, comprising:
receiving beacons transmitted by each of a plurality of the unconfigured network devices indicating its ability to join a wireless mesh network;
identifying, from among the plurality of unconfigured network devices, a plurality of said devices that are able to join the wireless mesh network;
establishing a temporary network connection between the primary device and each of the plurality of unconfigured network devices that are able to join the wireless mesh network;
generating a list of potential new nodes for the wireless mesh network comprising the plurality of unconfigured network devices that have established a temporary network connection with the primary device;
transmitting authentication credentials for the wireless mesh network to a selection of the unconfigured network devices to be added to the wireless mesh network; and
authenticating the selected unconfigured network devices to join the wireless mesh network.

2. The method of claim 1, wherein each of the primary device and unconfigured network devices are wireless routers.

3. The method of claim 1, wherein at least one of the primary device and the unconfigured network devices is a camera, a media player, an alarm system, or a smart home hub.

4. The method of claim 1, wherein the selection of unconfigured network devices to be added to the wireless mesh network is received from a client device.

5. The method of claim 1, wherein the selection of unconfigured network devices to be added to the wireless mesh network is determined by the primary device in accordance with one or more factors.

6. The method of claim 5, wherein the factors include the type of devices, a maximum number of nodes desired for the wireless mesh network, signal strength, and device transmission and reception speed.

7. The method of claim 6, further comprising:
using one or more said factors to identify an unconfigured network device that may degrade the performance of the wireless mesh network; and
determining not to add said unconfigured network device to join the wireless mesh network.

8. The method of claim 1, wherein:
the authentication credentials are transmitted to all unconfigured network devices;
the authentication credentials can be deciphered by only the unconfigured network devices selected to join the wireless mesh network.

9. A device for managing a wireless mesh network, configured to:
receive beacons transmitted by a plurality of unconfigured network devices indicating the ability of each device to join a wireless mesh network;
identify, from among the plurality of unconfigured network devices, a plurality of said devices that are able to join the wireless mesh network;
establish a temporary network connection with each of the plurality of unconfigured network devices that are able to join the wireless mesh network;
generate a list of potential new nodes for the wireless mesh network comprising the plurality of unconfigured network devices that have established a temporary network connection with the primary device;
transmit authentication credentials for the wireless mesh network to a selection of the unconfigured network devices to be added to the wireless mesh network; and
authenticate the selected unconfigured network devices to join the wireless mesh network.

10. The device of claim 9, wherein each of the device and unconfigured network devices are wireless routers.

11. The device of claim 9, wherein at least one of the device and the unconfigured network devices is a camera, a media player, an alarm system, or a smart home hub.

12. The device of claim 9, further configured to receive a selection of unconfigured network devices to be added to the wireless mesh network from a client device.

13. The device of claim 9, further configured to automatically select the unconfigured network devices to be added to the wireless mesh network in accordance with one or more factors.

14. The device of claim 13, wherein the factors include the type of devices, a maximum number of nodes desired for the wireless mesh network, signal strength, and device transmission and reception speed.

15. The device of claim 14, further configured to:
use one or more said factors to identify an unconfigured network device that may degrade the performance of the wireless mesh network; and
determine not to add said unconfigured network device to join the wireless mesh network.

16. The device of claim 9, further configured to:
transmit the authentication credentials to all unconfigured network devices;
wherein the authentication credentials can be deciphered by only the unconfigured network devices selected to join the wireless mesh network.

17. A communication system, comprising:
a plurality of wireless routers communicatively coupled to each other to form a wireless mesh network;
wherein one of the wireless routers is a primary router capable of detecting a plurality of unconfigured routers and adding them to the wireless mesh network;
a client device communicatively coupled to the primary router;
wherein the client device is capable of:
providing an interface to a user to allow the user to select a plurality of unconfigured routers to be added to the wireless mesh network;
instructing the primary router to add a plurality of unconfigured routers to the wireless mesh network; and
wherein the primary router is configured to add only the unconfigured routers selected by the user to the wireless mesh network.

18. The system of claim 17, further comprising at least one of a camera, a media player, an alarm system, and a smart home hub that may be added as a new node to the wireless mesh network.

19. The system of claim 17, wherein the client device is further capable of providing information regarding the signal strength, data throughput of each node, or the data volume handled by each router of the wireless mesh network.

20. The system of claim 19, wherein the client device is further capable of using said information to provide recommendations to the user regarding the optimum number of and placement of routers to improve performance of the wireless mesh network.
